(19) United States
(12) Patent Application Publication
(10) Pub. No.: US 2011/0184823 A1
(43) Pub. Date: Jul. 28, 2011

(54) INCENTIVE PROGRAM FOR POINT-OF-SALE OPERATORS

(76) Inventor: Simon Phillips, York (GB)

(21) Appl. No.: 12/695,418

(22) Filed: Jan. 28, 2010

(51) Int. Cl. G06Q 30/00; G06K 7/00

(52) U.S. Cl. 705/18; 235/380

(57) ABSTRACT

A method includes receiving point-of-sale (POS) operator identification information via a POS terminal. The POS operator identification information identifies an individual POS operator. The method further includes receiving transaction information indicative of an amount paid for a transaction and a mode of payment for the transaction. In addition, the method includes assigning incentive points to an account that belongs to the individual POS operator, based at least in part on the mode of payment and the POS operator identification information.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal. The authorization request is routed from the merchant's acquiring financial institution (“acquirer”) to a server computer operated by or on behalf of the issuer of the payment account. The issuer's server computer provides a response to the authorization request. If the response indicates that the issuer has authorized the transaction, the transaction is consummated at the point of sale. Later the transaction is cleared for settlement via the acquirer and the issuer.

More recently, cards that incorporate an integrated circuit (IC) have been utilized as payment cards. One well known IC payment card standard is referred to in the United States by the brand name “PayPass” and was established by MasterCard International Incorporated, the assignee hereof. Cards used in accordance with the PayPass standard include an IC that stores a payment card account number. The cards also include an antenna that is connected to the IC. During a purchase transaction, the payment card account number and other information may be uploaded from the IC payment card to the POS terminal via wireless RF (radio frequency) signaling with a proximity reader that is part of the POS terminal. Authorization and clearing may then proceed in substantially the same manner as for a transaction initiated with a mag stripe payment card (putting aside additional security measures that may be implemented by using the processing capabilities of the IC payment card and chip data in the clearing). Wireless RF IC payment cards are also sometimes referred to as “contactless” payment cards.

It has been proposed that the capabilities of a contactless payment card be incorporated into a mobile telephone, thereby turning the mobile telephone into a contactless payment device. Typically a mobile telephone/contactless payment device includes integrated circuitry with the same functionality as the RFID (radio frequency identification) IC of a contactless payment card. In addition, the mobile telephone/contactless payment device includes a loop antenna that is coupled to the payment-related IC for use in sending and/or receiving messages in connection with a transaction that involves contactless payment.

Contactless payment devices in other form factors, such as key fobs, wristwatches, wristbands and stickers, have also been proposed. According to other proposals, a contactless payment device in the form of a small card or sticker may be adhered or otherwise secured to a mobile telephone.

In addition to contactless payment cards, there have also been proposals to utilize so-called “contact” IC cards as payment devices for use with payment card systems. Such cards include a set of conductive contacts located on the card surface and connected to the IC in the card. Such cards may be interfaced to the POS terminal via a reader that provides a conductive connection to the contacts on the IC payment card.

One reason for development of IC payment devices in addition to magnetic stripe payment cards has been to enhance convenience during transactions at the point of sale. For example, in the PayPass system, the cardholder need only tap his/her contactless payment device on the proximity reader to allow the necessary wireless communication exchange of information to occur. This may prove to be more expeditious than swiping a mag stripe card through a mag stripe reader, thereby saving time in each transaction and increasing throughput at the check-out counter. However, it is often the case that consumers continue with their habitual use of a magnetic stripe payment card even after a contactless payment fob or other contactless payment device has been issued to them. As a result, adoption of newer payment technologies may be delayed, causing inefficiency for both consumers and retailers.

The present inventor has recognized that point-of-sale (POS) operators (also referred to as sales clerks or check-out clerks) may have a significant role in influencing consumer behavior with respect to adopting or not adopting new modes of payment. If a POS operator encourages the use of a certain type of payment device, customers with whom the POS operator interacts are more likely to use that type of payment device; if POS operators are discouraging with respect to a certain type of payment device, their customers may be less likely to use it.

The present inventor now proposes a system of incentives for POS operators which may lead them to support use of certain modes of payment by the customers they serve.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that schematically illustrates a payment card system provided in accordance with the present invention.

FIG. 2 is a block diagram that schematically illustrates an alternative embodiment of the system of FIG. 1.

FIG. 3 is a block diagram that schematically illustrates a computer that may be operated by or on behalf of an acquirer in the system of FIG. 1.

FIG. 4 is a block diagram that schematically illustrates a computer that may be operated by a merchant in the system of FIG. 2.

FIG. 5 is a block diagram that schematically illustrates a server computer that may store POS operator incentive accounts in the system of FIG. 1 or FIG. 2.

FIG. 6 is a flow chart that illustrates a process that may be performed by the computer of FIG. 3 in accordance with aspects of the present invention.

FIG. 7 is a flow chart that illustrates some details of the process of FIG. 6.

FIG. 8 is a flow chart that illustrates a process that may be performed by the computer of FIG. 4 in accordance with aspects of the present invention.

FIG. 9 is a flow chart that illustrates a process that may be performed by the computer of FIG. 5.

### DETAILED DESCRIPTION

In general, and for the purpose of introducing concepts of embodiments of the present invention, POS operators log-in to POS terminals and thereafter are credited with incentives for each transaction they handle that is paid for with a certain type or category of payment device or payment account. The system may detect the transactions which qualify for incentives on a centralized basis or alternatively at the POS terminals themselves. If qualifying transactions are to be identified on a centralized basis, this may occur, for example, at the acquirer, and this may be facilitated by messaging to the acquirer from the POS terminals to identify to the acquirer which POS operator is on duty at each POS terminal.

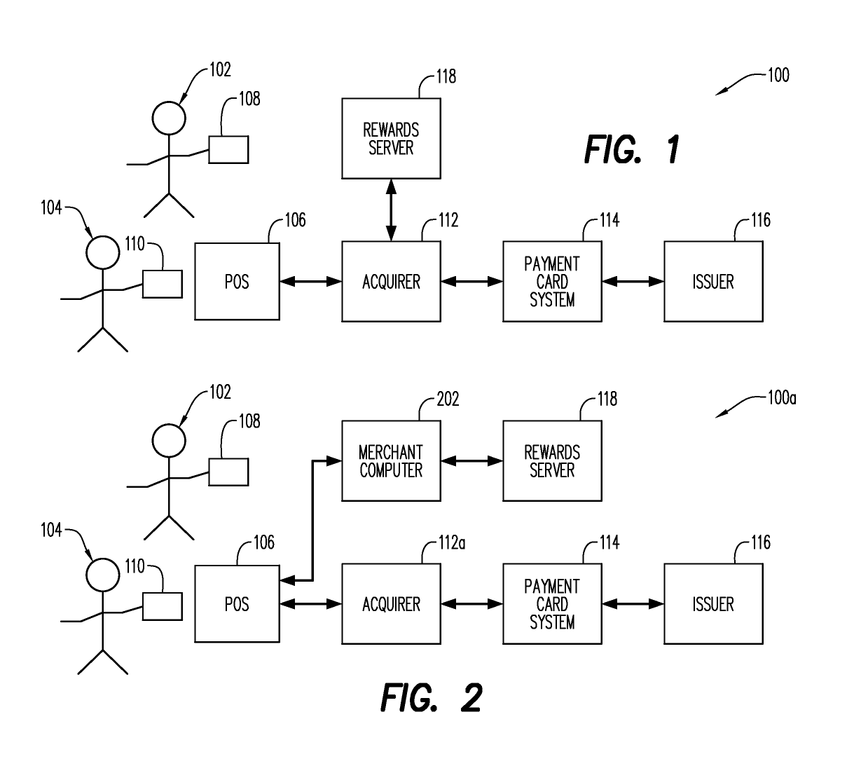

FIG. 1 is a block diagram that schematically illustrates a payment card system 100 provided in accordance with the present invention.

In FIG. 1, a POS operator 102 and a cardholder 104 are shown adjacent a POS terminal 106. The POS operator 102 has an identification card or token 108, which may be a mag stripe card, a contactless smart card, an RFID fob, etc. The POS operator 102 uses the card or token 108 to sign in to the POS terminal 106, thereby identifying himself/herself to the POS terminal 106 and to the system 100. It will be understood that the card or token 108 contains an identification number or the like that uniquely identifies the POS operator 102 (at least among the POS operator's fellow employees) and that the card or token 108 transmits the POS operator identification number to the POS terminal 106. This may occur via a mag stripe reader (not separately shown) or a proximity reader (not separately shown) or a contact smart card reader (not separately shown) that is part of the POS terminal 106.

The cardholder 104 has a conventional payment device (e.g., mag stripe card, contactless payment device, payment-enabled mobile telephone) 110 which the cardholder presents to the reader component (not separately shown) of the POS terminal 106 for the purpose of settling a purchase transaction.

The POS terminal 106 may be largely or entirely conventional in its hardware aspects. Thus, as is customary, the POS terminal 106 may include a processor (not separately shown) and program memory (not separately shown) coupled to the processor and storing software instructions for controlling the processor and hence the POS terminal 106. The operation of the POS terminal 106 may also be generally conventional, but may in some embodiments also include communications or messaging required to implement features of the present invention and may be implemented by the above-referenced software instructions.

Block 112 in FIG. 1 represents a computer that is operated by or on behalf of an acquirer (acquiring financial institution) that has a relationship with the merchant that operates the POS terminal 106 and employs the POS operator 102. In accordance with conventional practices, the acquirer computer 112 submits transaction authorization requests that originate from the POS terminal 106 to a payment card system 114 for routing to the issuer 116 of the cardholder's payment device 110. The payment card system 114 may be conventional in operation and may be like the system operated by MasterCard International Incorporated or other well-known systems that compete with the MasterCard system. The issuer may be one of numerous banks that issue payment card accounts. To simplify the drawing, only one issuer is shown, and in general the drawing is illustrative of a single transaction, from among many that may occur daily, or even simultaneously, in the system 100. Thus, for example, the cardholder 104 is one of numerous consumers who participate in the system. The POS terminal 106 is one of many such terminals that are part of the system, and the POS operator 102 is only one of such merchant employees who handle transactions in the system. Similarly, numerous other payment devices may be used with the system in addition to the payment device 110 shown in the drawing, and each of the other merchant employees has his/her own identification card or token.

In addition to its conventional function of receiving and forwarding transaction authorization requests, and receiving and relaying authorization responses, the acquirer computer 112 may also, in some embodiments and in accordance with aspects of the invention, identify transactions for which incentive points or the like are to be awarded to the POS operator 102. Details of the acquirer computer 112 and of how it facilitates a POS operator incentive system will be described below.

Reference numeral 118 in FIG. 1 represents a server computer that is in communication with the acquirer computer 112. The server computer 118 may store and periodically update incentive (rewards) account records for the various POS operators who staff the system 100 at POS terminals 106.

In FIG. 1, the POS terminal 106 is shown as directly exchanging messages with the acquirer computer 112. While this may be the case in some instances, it may alternatively be the case that one or more other computers are present in the message flow between the POS terminal 106 and the acquirer computer 112. For example, the merchant that operates the POS terminal 106 may also operate one or more computers (not shown) which receive transaction information from the POS terminal (along with such information from other POS terminals which are not shown) and forward resulting authorization requests to the acquirer computer 112. It should also be noted that there may be computing resources operated by a transaction processing contractor between the merchant computer/POS terminal and the acquirer computer 112. Further, the acquirer computer 112 itself may be operated by a transaction processing contractor rather than by the actual bank which serves as acquirer for the merchant.

FIG. 2 is a block diagram that schematically illustrates an alternative embodiment 100a of the system of FIG. 1. The system 100a and its constituent components may be similar to the system as shown in FIG. 1, except that in the system 100a of FIG. 2, the acquirer computer (reference numeral 112a) may operate only in a conventional manner to handle transaction authorization requests and authorization responses, and may serve no role with respect to identifying transactions that qualify for POS operator incentives. Instead, the latter function may be performed by a merchant computer 202. The merchant computer 202 may be in communication with the POS terminal 106 and the rewards server computer 118. Details of the merchant computer 202 and its operation will be provided below.

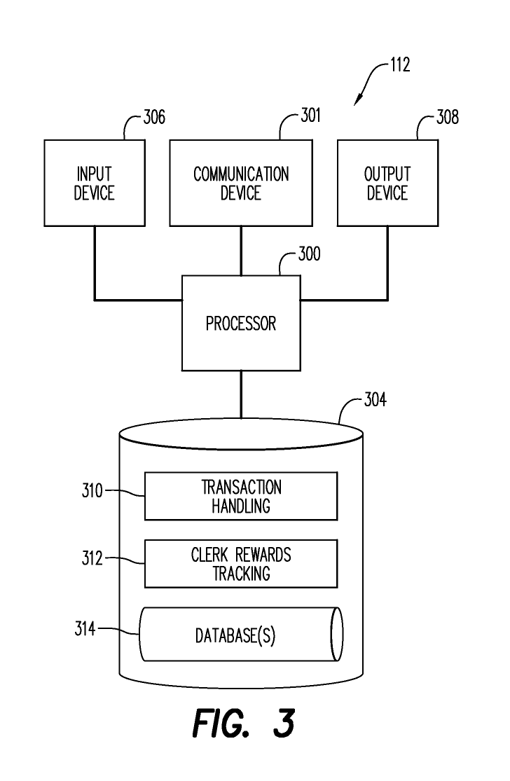

FIG. 3 is a block diagram that schematically illustrates the acquirer computer 112.

The acquirer computer 112 may be conventional in its hardware aspects but may be controlled by software to cause it to function as described herein. For example, the acquirer computer 112 may be constituted by conventional server computer hardware.

The acquirer computer 112 may include a computer processor 300 operatively coupled to a communication device 301, a storage device 304, an input device 306 and an output device 308.

The computer processor 300 may be constituted by one or more conventional processors. Processor 300 operates to execute processor-executable steps, contained in program instructions described below, so as to control the acquirer computer 112 to provide desired functionality.

Communication device 301 may be used to facilitate communication with, for example, other devices (such as the payment system network and/or the rewards server 118). For example, communication device 301 may comprise numerous communication ports (not separately shown), to allow the acquirer computer 112 to communicate simultaneously with a number of other computers or other devices, so that, for example, the acquirer computer 112 is able to simultaneously handle numerous transaction originating from numerous merchants and/or numerous POS terminals.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the acquirer computer 112, executed by the processor 300 to cause the acquirer computer 112 to function as described herein.

The programs may include a transaction handling application program 310 that controls the processor 300 to enable the acquirer computer 112 to handle and forward transaction authorization requests for routing in the payment card system 114, and also to handle and relay authorization responses received from payment card issuers via the payment card system 114. In some embodiments, the transaction handling application program 310 may be substantially or entirely conventional.

The programs may further include a clerk (POS operator) rewards tracking application program 312 provided in accordance with aspects of the present invention. As will be understood from subsequent discussion, the clerk rewards tracking application program 312 may control the acquirer computer 112 so that it tracks and assigns incentive points to the POS operator 102 who is operating the POS terminal 106 at any given time.

The storage device 304 may also store, and the acquirer computer 112 may also execute, other programs, which are not shown. The other programs may include, e.g., one or more conventional operating systems, device drivers, communication software, database management software, etc. The storage device 304 may also store one or more databases 314 required for operation of the acquirer computer 112.

Although only a single acquirer computer 112 has been referred to up to now, it should be understood that the functions performed by the acquirer computer 112 may in practice be divided among two or more cooperating computer systems. Accordingly, when the term “computer” is used herein or in the appended claims, that term should be understood to include one computer or two or more cooperating computers. Similarly, the term “processor” should be understood to include one processor or two or more cooperating processors.

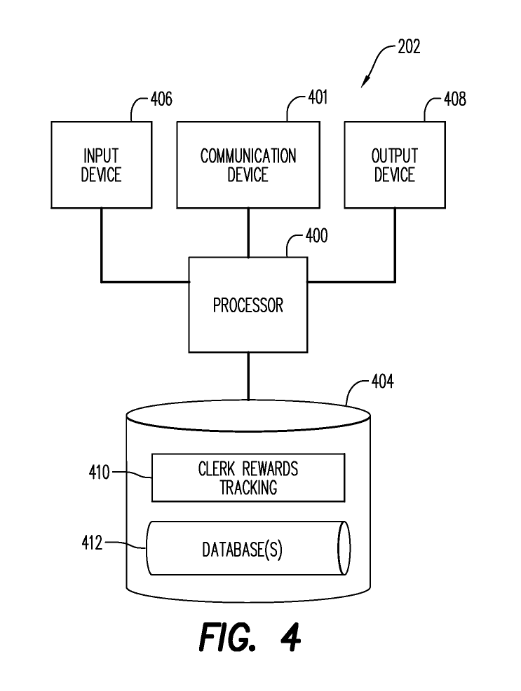

FIG. 4 is a block diagram that schematically illustrates the merchant computer 202 shown in FIG. 2.

The hardware architecture of the merchant computer 202 may be conventional and may be the same as that of the acquirer computer 112. Thus, the above description of the hardware aspects of the acquirer computer 112 is equally applicable to the hardware aspects of the merchant computer 202. Nevertheless, the following description is provided to summarize the hardware components of the merchant computer 202.

The merchant computer 202 may include a processor 400 that is in communication with a communication device 401, a storage device 404, an input device 406 and an output device 408. The storage device 404 may store a clerk rewards tracking application program 410. The clerk rewards tracking application program 410 may be similar in its functionality to the clerk rewards tracking application program 312 referred to above in connection with the acquirer computer 112 of FIG. 3. Accordingly, the discussion below of the clerk rewards tracking application program 312 is also relevant to the clerk rewards tracking application program 410. Certain possible differences between the two programs will also be described below.

The storage device 404 may also store, and the merchant computer 202 may also execute, other programs, which are not shown. The other programs may include, e.g., one or more conventional operating systems, device drivers, communication software, database management software, etc. In addition, the storage device 404 may store one or more databases 412 used in connection with operations of the merchant computer 202.

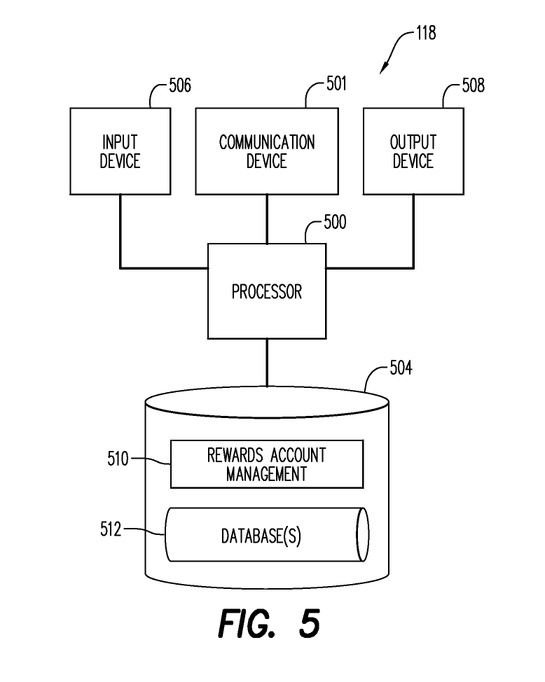

FIG. 5 is a block diagram that schematically illustrates the rewards server computer 118 that may store POS operator incentive accounts in the system of FIG. 1 or FIG. 2.

The hardware architecture of the rewards server 118 may be conventional and may be the same as that of the acquirer computer 112. Thus, the above description of the hardware aspects of the acquirer computer 112 is equally applicable to the hardware aspects of the rewards server 118. Nevertheless, the following description is provided to summarize the hardware components of the rewards server 118.

The rewards server 118 may include a processor 500 that is in communication with a communication device 501, a storage device 504, an input device 506 and an output device 508. The storage device 504 may store an application program 510 that updates and manages incentive (rewards) points accounts for POS operators employed by merchants in connection with the system 100 or 100a. Aspects of the rewards account management application program 510 will be described below.

The storage device 504 may also store, and the rewards server 118 may also execute, other programs, which are not shown. The other programs may include, e.g., one or more conventional operating systems, device drivers, communication software, database management software, web hosting software, etc. In addition, the storage device 504 may store one or more databases 512 used in connection with operations of the rewards server 118.

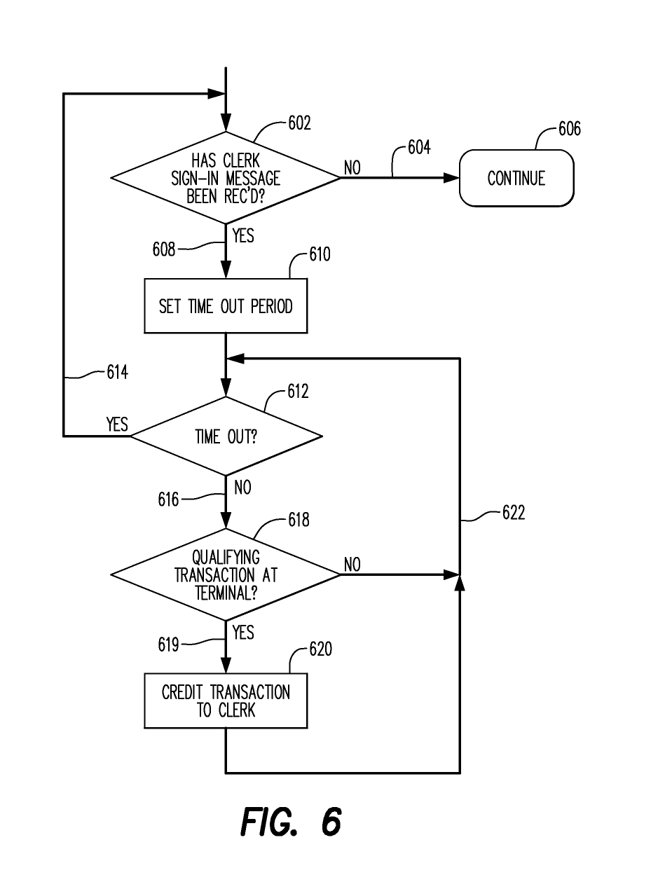

FIG. 6 is a flow chart that illustrates a process that may be performed by the acquirer computer 112 (FIGS. 1 and 3) in accordance with aspects of the present invention. However, before discussing details of FIG. 6, a context for that drawing will first be described in the form of an example implementation of a POS operator rewards/incentive program in the system 100.

It will first be assumed for purposes of this example that the business objective is to foster consumer adoption of a particular payment technology—say, contactless payment stickers to be adhered to mobile telephones. For this purpose, it will further be assumed that all of the stickers are being issued by a single large bank (hereinafter “BigBank”) and will carry a BIN (bank identification number—i.e., the first N digits of the payment card account number) that is only carried by the contactless payment stickers. For convenience of reference, a further assumption is that the promotional name “Go-Pay-Phone” has been adopted to refer to mobile phones that have one of the contactless payment stickers attached thereto.

Further, BigBank in addition to being a payment card issuer, also serves as an acquiring financial institution for a number of large retailers, and even more small and medium-sized retailers. In addition, BigBank has also entered into cooperative relationships with other banks that serve as acquirers for many retailers not so served by BigBank. One of the other acquirers in cooperation with BigBank will hereafter be referred to as “MegaBank”.

BigBank's business solution for promoting consumer adoption and use of Go-Pay-Phone involves educating and providing incentives to POS operators to encourage consumers to use Go-Pay-Phone as a mode of payment at the stores where the POS operators are employed. One of those stores is owned by a retailer called “StoreOne”, and is the location for the POS terminal 106 shown in FIG. 1. By the same token, the POS operator 102 shown in FIG. 1 is an employee of StoreOne. The acquirer for StoreOne, and the operator (directly or via contractor) of the acquirer computer 112, is MegaBank.

BigBank's incentive program for POS operators calls for each POS operator enrolled in the program to receive one incentive point for each transaction consummated using a Go-Pay-Phone at a POS terminal while the POS operator in question is logged in to the particular POS terminal. To keep from crediting POS operators beyond their shifts (e.g., when the next operator at the terminal fails to log in), POS operators are required to renew their log-in at regular intervals, say every hour, if they wish to continue to be eligible for incentive points for qualifying transactions during their shift. POS operators each are issued an identification token such as a mag stripe card or contactless IC card (item 108 in FIG. 1) that the operator may swipe or tap (as the case may be) on a reader component of the POS terminal 106 to log-in or renew their log-in at hourly intervals.

The POS operators' incentive points accounts are maintained on the rewards server 118, which may be operated by or on behalf of BigBank. Incentive points in the program may be redeemable for merchandise, travel, and/or cash, depending on details of the program. (In some embodiments, the incentive points may just be cash credits.)

When a POS operator logs-in or renews his/her log-in at the POS terminal 106, the POS terminal 106 sends a message containing the POS operator's unique ID number (i.e., at least unique among operators at that retailer or at that location), directly or indirectly, to the acquirer computer 112. The message may be similar in format to conventional transaction authorization request messaging, but serves the unique and novel function of notifying the acquirer computer 112 as to what operator is currently logged in at the POS terminal in question, and hence is entitled to incentive points credit for the ensuing qualified transactions at the terminal. As transactions occur, these result in conventional transaction authorization request messaging from the POS terminal 106, directly or indirectly, to the acquirer computer 112.

BigBank and its cooperating acquirers work with a number of large retailers to train and encourage or require the retailers' check-out employees to encourage customers to use Go-Pay-Phone to settle their purchase transactions at the retailers. Even relatively small incentives cause the check-out employees/POS operators to consistently suggest to customers that they use Go-Pay-Phone for their transactions. With encouragement from the POS operators, customers increase their use of Go-Pay-Phone. Particularly with regular customers, POS operators also encourage those who don't have Go-Pay-Phone to apply for the necessary contactless stickers. Application forms for this purpose are readily available and are handed out at check-out counters.

The customers and retailers benefit from faster transaction processing and greater efficiency at the point of sale. BigBank and its allied banks benefit from the successful introduction of new payment technology.

Having sketched out an example implementation of the invention, the discussion will now turn to FIG. 6, which illustrates “back office” processing at the acquirer computer 112 that makes the POS operator incentive program work. As such, the process illustrated at FIG. 6 is illustrative of functionality provided by the clerk rewards tracking application program represented by block 312 in FIG. 3. In particular, the process of FIG. 6 relates to one processing thread relating to incentive-program-related processing for one POS terminal and one POS operator for a limited period of time. Numerous other similar processing threads may be active in the acquirer computer 112 at the same time for other terminals/operators.

At decision block 602 in FIG. 6, the acquirer computer 112 determines, with respect to the POS terminal 106, whether a message has been received from the terminal in question to indicate that a particular POS operator has logged-in (signed-in) to the terminal. If not, then as indicated by branch 604 from decision block 602, the processing continues (block 606) without beginning to identify and track clerk rewards qualifying transactions from the POS terminal 106.

However, if the acquirer computer 112 makes a positive determination at decision block 602 (i.e., if a message indicating operator sign-in at POS terminal 106 is received by the acquirer computer 112), then the process of FIG. 6 advances via branch 608 from decision block 602 to block 610. At block 610, the acquirer computer 112 sets a time-out period for the POS terminal 106. The effect of the time-out period is that, until the time-out period expires, the acquirer computer 112 will credit qualifying transactions (i.e., will credit incentive points in regard to qualifying transactions) for the benefit of the incentive points account for the particular POS operator identified in the message received at decision block 602. In some embodiments, for example, the time-out period has a duration of one hour or a few minutes longer than one hour. In other embodiments, the time-out period may be longer or shorter than one hour. Also, as will be seen, the time-out period may be effectively extended in response to the acquirer computer 112 receiving another message to indicate that the same POS operator has renewed his/her sign-in.

From block 610, the process of FIG. 6 advances to decision block 612. At decision block 612, the acquirer computer 112 determines whether the time-out period set at 610 has expired. If so, the process loops back from decision block 612 via branch 614 to decision block 602. If not, the process advances from decision block 612 via branch 616 to decision block 618.

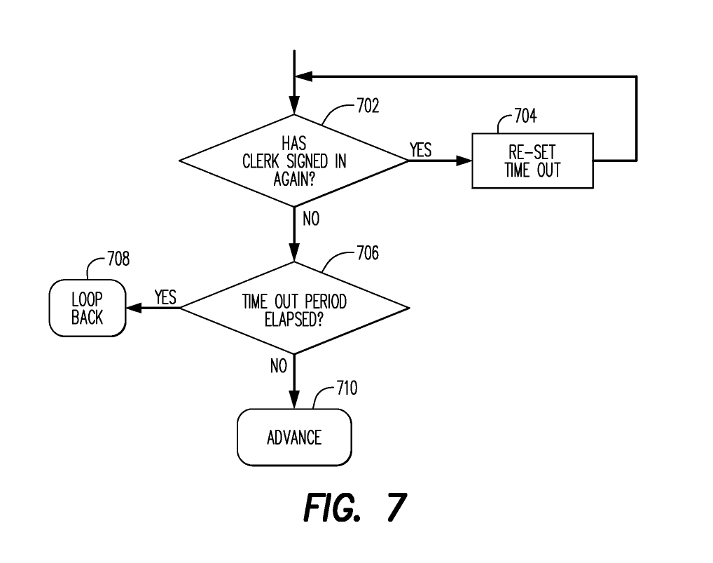

FIG. 7 is a flow chart that shows details of processing involved with decision block 612 in FIG. 6. At decision block 702 in FIG. 7, the acquirer computer 112 determines whether the POS operator previously signed in at the particular POS terminal has renewed his/her sign-in (as indicated by other clerk ID message from the POS terminal). If so, then the process of FIG. 7 advances to block 704 (at which the time-out period is re-set (e.g., for another hour or hour-plus), and the process loops back again to decision block 702.

If a negative determination is made at decision block 702, then the process of FIG. 7 advances from decision block 702 to decision block 706. At decision block 706, the acquirer computer 112 determines whether the time-out period (as re-set, if applicable, at block 704) has elapsed. If so, then the process of FIG. 7 loops back (block 708)—i.e., follows branch 614 in FIG. 6. if not, then the process of FIG. 7 advances (block 710)—i.e., follows branch 616 in FIG. 6.

Referring again to FIG. 6, consideration will now be given to decision block 618. At decision block 618, the acquirer computer 112 determines whether a qualifying transaction has occurred at the particular POS terminal. For purposes of this example, the definition of qualifying transaction is one that is authorized by the issuer and that is settled using a favored mode of payment. In terms of the current example, the favored mode of payment is assumed to be a Go-Pay-Phone. It will be recalled that each Go-Pay-Phone corresponds to a specific BIN that is included in the account number for all of the contactless payment stickers used for the Go-Pay-Phone, where that BIN is used only for the contactless payment stickers. Thus, a qualifying transaction in this example is one (a) that includes the required BIN in the payment card account number, and (b) for which a favorable authorization response is received from the issuer (FIG. 1, block 116).

If, at decision block 618, the acquirer computer 112 determines that a qualifying transaction has come through (been requested and subsequently authorized) via the POS terminal in question, then the process of FIG. 6 advances via branch 619 from decision block 618 to block 620. At block 620, the acquirer computer 112 stores information and/or sends a message regarding the qualifying transaction to indicate that the POS operator currently signed in to the POS terminal is to be credited with an incentive point with regard to the transaction. For example, the acquirer computer 112 may, over the course of a day, store data reflecting all incentive points to be credited to all POS operators for qualifying transactions during the day. Then, at the end of the day, the acquirer computer 112 may upload the data to the rewards server 118 (FIG. 1) such that the POS operators' incentive accounts stored in the rewards server 118 are updated to reflect the additional incentive points to which they are entitled.

Following block 620, the process of FIG. 6 loops back to decision block 612.

Considering decision block 618 again, so long as no qualifying transaction is received from the POS terminal in question, the process of FIG. 6 loops back via branch 622 from decision block 618 to decision block 612, without advancing to block 620. Consequently, the process loops through decision blocks 612 and 618 until either a qualifying transaction is received via the POS terminal 106 or the time-out period expires.

With the acquirer computer 112 operative as described in connection with FIGS. 6-7, POS operators' entitlement to incentive points can be tracked on a centralized basis utilizing messaging from the PUS terminals operated by the PUS operators. The messaging from the POS terminals can be entirely conventional, except for the relatively few additional and novel messages from the POS terminals to indicate operator sign-ins to the acquirer computer 112. Accordingly, an incentive program to encourage POS operators to promote use of a particular mode of payment for transactions can be implemented in this manner with only a small amount of new programming for the POS terminals.

Alternatively, with the system architecture illustrated in FIG. 2, a similar incentive program for POS operators may be implemented with a moderate additional burden on the POS terminals. In this case, the PUS terminals may be required to report POS operator sign-ins and all authorized payment device transactions to the merchant computer 202 (FIG. 2). This would result in a somewhat increased messaging overhead for the POS terminals, along with some re-programming of the POS terminals. However, with this system architecture, the operation of the acquirer computer 112a (shown in FIG. 2) may be entirely conventional.

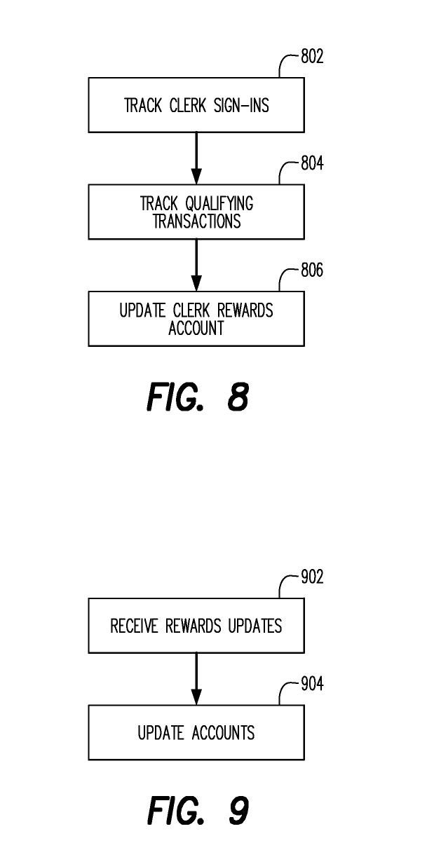

FIG. 8 is a flow chart that illustrates a process that may be performed by the merchant computer 202 in accordance with aspects of the present invention.

At 802 in FIG. 8, the merchant computer 202 tracks POS operator sign-ins at the PUS terminal 106. The merchant computer 202 may do this based on operator identification messages received by the merchant computer 202 from the POS terminal 106, and may occur in a similar fashion to above-described aspects of the process of FIGS. 6 and 7.

At 804 in FIG. 8, the merchant computer 202 tracks transactions at the POS terminal 106 that qualify for crediting incentive points to the POS operator currently signed-in to the PUS terminal 106. This, too, may be based on messages from the POS terminal 106. In particular, as noted above, the POS terminal 106 may report to the merchant computer 202, by payment card account number, all payment device transactions for which a favorable authorization response was received by the POS terminal 106. Then, similarly to the above-described process of FIG. 6, the merchant computer 202 may determine whether the BIN in the account number is indicative of use of a Go-Pay-Phone for the transaction. If so, the merchant computer 202 may cause an incentive point for the transaction to accrue to the POS operator 102 who is currently signed-in to the POS terminal 106.

At 806 in FIG. 8, the merchant computer 202 stores information and/or forwards the information to the rewards server 118 (shown in FIG. 2 as well as in FIG. 1) so that the incentive points are duly credited by the rewards server 118 to the accounts of the POS operators.

FIG. 9 is a flow chart that illustrates a process that may be performed by the rewards server 118.

At 902, the rewards server 118 receives from the acquirer computer 112 (FIG. 1) or from the merchant computer 202 (FIG. 2), as the case may be, data reporting incentive points that should be credited to POS operators' accounts (and/or qualifying transactions for which incentive points are due). At 904, the rewards server 118 updates the POS operators' incentive accounts based on the information received at 902.

In other embodiments of the invention, more substantial programming of the POS terminals may be undertaken, so that the POS terminals themselves detect when qualifying transactions occur, and communicate incentive points updates for the POS operators to the rewards server 118.

In an example embodiment described above, the favored mode of payment was the “Go-Pay-Phone” (i.e., a contactless payment sticker distributed for attachment to mobile telephones), and qualifying transactions were detected based on the BIN assigned to all of the contactless payment stickers. However, in other embodiments, the favored mode of payment may be defined in another way, and whether a transaction qualifies for incentive credit to the POS operator may be determined based on transaction data other than the BIN. For example, it has been proposed that transaction authorization messages include a data field for indicating whether the transaction was initiated by reading a payment device with a proximity reader (i.e., an indication as to whether a contactless payment device was presented to settle the transaction). In the case where an incentive program is intended to promote use of contactless payment devices generally, the contactless/non-contactless data field indication may be used (e.g., by the acquirer computer 112—FIG. 1) to identify qualifying transactions.

It should also be understood that the “favored mode of payment” can be defined more broadly or more narrowly than in the examples previously described. For another example, a merchant or a consortium of issuers, may initiate a POS operator incentive program to promote use of any and all non-cash and non-check payments—i.e., to promote use of any and all payment devices, including mag stripe payment cards, contactless payment cards, fobs, etc., contact IC payment cards, payment-enabled mobile telephones (a species of contactless payment device), et al. In such a program, every transaction submitted and approved through the payment card system (every authorized transaction passing through the acquirer computer 112) would be a qualified transaction.

In another example embodiment, a POS operator incentive program may be intended to promote all payment devices issued by a single issuing bank. In this case, again the appropriate BIN or BINs could be designated as indicative of qualifying transactions. With this example, in situations where the sponsoring payment device issuer is also the acquirer for a given retailer, all “on-us” payment device transactions that are authorized are also automatically qualifying transactions, while all transactions that need to be routed to other issuers are ipso facto not qualifying. In a promotion of this type, the issuer may choose to focus its efforts only on retailers that it also serves as an acquirer, so that only LOS operators who are employed by those retailers are enrolled in this example incentive program.

Other example POS operator incentive programs may be aimed at promoting another type of device besides the notional Go-Pay-Phone as referred to above, such as all (but only) payment-enabled mobile telephones (i.e., phones that have contactless payment functionality integrated therein); or all (but only) contactless payment fobs; or all (but only) payment-enabled wristwatches, etc.

In some embodiments, detection of qualifying transactions may occur at the level of the payment card system 114 (FIGS. 1 and 2) rather than or in addition to detecting such transactions at the acquirer 112 (FIG. 1) or at the merchant computer 202 (FIG. 2), as described above. For this purpose messaging related to POS operator sign-ins may be forwarded to the payment card system 114 from the POS terminal 106 via the acquirer 112. Moreover, the payment card system 114 may engage in communications with the rewards server 118 to update the POS operators' incentive accounts to reflect qualifying transactions detected by the payment card system 114. In some embodiments, all transactions that utilize a payment device bearing a certain brand (e.g., MasterCard, Visa, American Express, etc.) may qualify for incentive credit. Other types of incentive schemes could also be implemented with detection of qualifying transactions at the payment card system.

In some embodiments, the issuer 116 may detect qualifying transactions instead of or in addition to this function being performed by other system components as described above. Again, messages about POS operator sign-ins may be forwarded to the issuer, and the issuer may communicate with the rewards server 118 to update POS operators' incentive accounts. This would, for example, facilitate an incentive scheme in which all transactions properly routed to and approved by the issuer qualify for incentive credit. Other types of incentive schemes could also be implemented with detection of qualifying transactions at the issuer.

In previous discussion, it has been indicated that the POS operators may use a mag stripe card, contactless IC card, or the like to sign-in at the POS terminals. In addition or alternatively, however, the POS operators may sign in by entering their ID numbers via the POS terminal keypad, or otherwise by manipulating the POS user interface (e.g., via a touchscreen).

In some embodiments, the POS terminal may be programmed to periodically prompt the POS operator to re-new his/her sign in. In some embodiments, the acquirer computer 112 or the merchant computer 202 may periodically send a message to the POS terminal to prompt the terminal, in turn, to issue a sign-in prompt to the operator. In other embodiments, the system may operate on the assumption that once a POS operator has signed in, he/she remains signed in until he/she signs out, or another operator signs in to the same POS terminal.

In some embodiments, the POS operator is credited with one or a fixed number of incentive points per qualifying transaction. In other embodiments, there may be different classes of qualifying transactions that accrue different numbers of incentive points. In some embodiments, the number of incentive points accruing to a transaction may vary with the monetary amount of the transaction.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions and operated under the name of MasterCard, Visa, American Express, Diners Club, Discover Card or a similar system. In some embodiments, the term “payment card system” may be limited to systems in which member financial institutions issue payment card accounts to individuals, businesses and/or other organizations.

As used herein and in the appended claims, the term “transaction information” refers to information entered into a POS terminal in connection with a purchase transaction, and includes a payment card account number and/or other information read from a payment device by the POS terminal, as well as a total transaction amount, information that identifies an item that is being purchased, date and time of purchase, merchant identification, POS terminal identification, etc.

Any block in a block diagram in the accompanying drawings that indicates an entity such as a merchant, an acquirer or an issuer, or a payment card system, should also be understood to represent one or more computers operated by or on behalf of such entity.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1.-18. (canceled)

19. A method comprising:
receiving, from a particular point-of-sale (POS) terminal, a first message from a merchant, the first message indicating that a particular individual POS operator is operating the particular POS terminal;
setting a time-out period in response to receiving the first message;
receiving a second message prior to expiration of the time-out period, the second message indicating a transaction performed at the particular POS terminal, the second message indicating a mode of payment for the transaction;
transmitting an authorization request for the transaction;
receiving a favorable response to the authorization request; and
crediting the transaction, by a rewards server, to an incentive account belonging to the particular individual POS operator in response to a plurality of conditions being satisfied, the plurality of conditions including: (a) the second message being received prior to expiration of the time-out period, (b) the favorable response to the authorization request, and (c) the mode of payment for the transaction being a favored mode of payment.

20. The method of claim 19, wherein the mode of payment is a contactless payment device.

21. The method of claim 20, wherein the mode of payment is a payment-enabled mobile telephone.

22. The method of claim 19, wherein the favored mode of payment is a payment account issued by a bank that serves the merchant as an acquirer in a payment card system.

23. The method of claim 19, wherein crediting the transaction to an incentive account of the particular POS operator comprises:
assigning incentive points to the incentive account based at least in part on the favored mode of payment and the POS operator identification information.

24. The method of claim 19, further comprising, prior to receiving the first message, the particular POS terminal receiving POS operator identification information via at least one of a magnetic stripe card reader and a proximity reader.

25. The method of claim 19, further comprising, prior to receiving the first message, the particular POS terminal receiving POS operator identification information via at least one of a keypad or touchscreen.

26. The method of claim 19, wherein the first message and the second message are received by an acquirer computer that is operated by or on behalf of an acquirer in a payment card system.

27. The method of claim 19, further comprising:
detecting expiration of the time-out period;
receiving a third message indicating a second transaction performed at the particular POS terminal with a favored mode of payment; and
not crediting the second transaction to the incentive account of the particular individual POS operator.

28. The method of claim 19, further comprising:
detecting expiration of the time-out period;
receiving a login message that indicates that the particular individual POS terminal operator is operating the particular POS terminal;
receiving a third message indicating a second transaction performed at the particular POS terminal with a favored mode of payment; and
crediting the second transaction to the incentive account of the particular individual POS operator.
